(19) United States
(12) Patent Application Publication
(10) Pub. No.: US 2025/0269762 A1
(43) Pub. Date: Aug. 28, 2025

(54) OPTIMIZED DESIGN FOR LOW VOLTAGE CHARGING FOR ELECTRIFIED VEHICLES

(71) Applicant: FCA US LLC, Auburn Hills, MI (US)

(72) Inventors: Abhilash Gudapati, Troy, MI (US); Rudolf Kharpuri, Auburn Hills, MI (US); Zhentao Xie, Auburn Hills, MI (US)

(21) Appl. No.: 18/589,523

(22) Filed: Feb. 28, 2024

(51) Int. Cl. B60L 58/12; B60L 58/20; G01R 31/3835; H01M 10/44

(52) U.S. Cl. CPC B60L 58/12; B60L 58/20; G01R 31/3835; H01M 10/44; B60L 2240/547; H01M 2220/20

(57) ABSTRACT

A low voltage battery charging control system for an electrified vehicle includes a supervisory controller configured to control a powertrain of the electrified vehicle and connected to a plurality of other electronic control units (ECUs) of the electrified vehicle via a controller area network (CAN), a first intelligent battery sensor (IBS) configured to generate a first set of measurements indicative of a first set of parameters, respectively, of a first low voltage battery system of the electrified vehicle, and a local interconnect network (LIN) bus connecting the supervisory controller and the first IBS, wherein the supervisory controller is configured to receive the first set of measurements from the first IBS via the LIN bus and control charging of the first low voltage battery system without waking up the CAN and the plurality of ECUs connected thereto and thereby avoiding any electrical power drain associated therewith.

### FIELD

The present application generally relates to electrified vehicles and, more particularly, to optimized systems and methods for low voltage, e.g., 12 volt (V), battery charging for electrified vehicles.

### BACKGROUND

Low voltage (e.g., 12V) batteries are often utilized for powering low voltage vehicle components and for any other suitable uses, such as cranking an internal combustion engine. Maintaining desired state of charge (SOC) levels (e.g., 90-95%) in these 12V batteries is critical for battery health/longevity and to avoid any other issues relating to their malfunction. In electrified vehicles, the charging of these 12V batteries is typically performed by stepping-down (e.g., via a DC-DC converter) a higher voltage associated with a high voltage bus/battery system. The 12V battery charging can occur during both vehicle power-on and power-off periods (i.e., while the vehicle is powered-down), which can include plug-in charging periods. Conventional electrified vehicles perform controller area network (CAN) based monitoring of the 12V battery system, which can result in excessive power drain. Accordingly, while such conventional electrified vehicle control systems do work for their intended purpose, there exists an opportunity for improvement in the relevant art.

### SUMMARY

According to one aspect of the invention, a low voltage battery charging control system for an electrified vehicle is presented. In one exemplary implementation, the low voltage battery charging control system comprises a supervisory controller configured to control a powertrain of the electrified vehicle, wherein the supervisory controller is connected to a plurality of other electronic control units (ECUs) of the electrified vehicle via a controller area network (CAN), a first intelligent battery sensor (IBS) configured to generate a first set of measurements indicative of a first set of parameters, respectively, of a first low voltage battery system of the electrified vehicle, and a local interconnect network (LIN) bus connecting the supervisory controller and the first IBS, wherein the supervisory controller is configured to receive the first set of measurements from the first IBS via the LIN bus and control charging of the first low voltage battery system without waking up the CAN and the plurality of ECUs connected thereto and thereby avoiding any electrical power drain associated therewith.

In some implementations, the first IBS is not connected to a body control module (BCM) or other vehicle network supervisor module via another LIN bus. In some implementations, the LIN bus is an preexisting LIN bus associated with the supervisory controller. In some implementations, the first low voltage battery system does not have a separate controller or control module. In some implementations, the first low voltage battery system is a 12 Volt lead-acid type battery. In some implementations, the first low voltage battery system is a 12 Volt absorbent glass material (AGM) type battery. In some implementations, the low voltage battery charging control system further comprises a second IBS configured to generate a second set of measurements indicative of a second set of parameters, respectively, of a second low voltage battery system of the electrified vehicle, and the LIN bus also connects the supervisory controller and the second IBS. In some implementations, the supervisory controller is a hybrid control processor (HCP).

According to another aspect of the invention, a low voltage battery charging control method for an electrified vehicle is presented. In one exemplary implementation, the low voltage battery charging control method comprises providing a supervisory controller connected to a plurality of other ECUs of the electrified vehicle via a CAN, wherein the supervisory controller is configured to control a powertrain of the electrified vehicle, providing a IBS configured to generate a first set of measurements indicative of a first set of parameters, respectively, of a first low voltage battery system of the electrified vehicle, providing a LIN bus connecting the supervisory controller and the first IBS, and receiving, by the supervisory controller, the first set of measurements from the first IBS via the LIN bus and controlling, by the supervisory controller, charging of the first low voltage battery system without waking up the CAN and the plurality of ECUs connected thereto and thereby avoiding any electrical power drain associated therewith.

In some implementations, the first IBS is not connected to a BCM or other vehicle network supervisor module via another LIN bus In some implementations, the LIN bus is an preexisting LIN bus associated with the supervisory controller. In some implementations, the first low voltage battery system does not have a separate controller or control module. In some implementations, the first low voltage battery system is a 12 Volt lead-acid type battery. In some implementations, the first low voltage battery system is a 12 Volt AGM type battery. In some implementations, the method further comprises providing a second IBS configured to generate a second set of measurements indicative of a second set of parameters, respectively, of a second low voltage battery system of the electrified vehicle, and the LIN bus also connects the supervisory controller and the second IBS. In some implementations, the supervisory controller is an HCP.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example low voltage battery charging control system according to the principles of the present application;

FIG. 2 is a functional block diagram of an example control architecture for the low voltage battery charging system according to the principles of the present application; and

FIG. 3 is a flow diagram of an example low voltage battery charging control method for an electrified vehicle according to the principles of the present application.

### DESCRIPTION

As previously discussed, conventional electrified vehicle control systems periodically wakeup a supervisory controller, which must then wakeup a controller area network (CAN) to request a body control module (BCM) or other similar module to obtain low voltage (e.g., 12V) battery measurements. This is typically performed for a short period of time to avoid excess 12V power drain, as all of the other electronic control units (ECUs) on the CAN are also woken up during this period. This is a very inefficient method of determining the 12V battery measurements, and also does not provide for continued measuring. One potential solution is to use an alternator connected to an internal combustion engine to charge the 12V battery, but this is limited to vehicle power-on conditions. Another potential solution to this problem includes using low voltage batteries with their own controllers, such as 12-16V lithium-ion (Li-ion) batteries with their own battery controllers, but this drastically increases costs and potentially weight/packaging. Thus, an opportunity for improvement exists in the art of vehicle low voltage battery charging control.

Accordingly, improved low voltage charging control systems and methods are presented herein. These systems and methods utilize conventional 12V lead-acid or absorbent glass material (AGM) type batteries each with an associated intelligent battery sensor (IBS) configured to measure parameters of the 12V battery system. This is a much less expensive configuration than the above-described 12-16V Li-ion battery with its own separate controller. Each IBS is connected directly to its 12V battery and to a supervisory powertrain controller (e.g., a hybrid control processor, or HCP) via an existing LIN bus. This allows for the supervisory controller to periodically wakeup and check the 12V battery measurements via the IBS(s) and the LIN without waking up the CAN and all of its associated ECUs. Thus, any associated CAN-based 12V power drain can be avoided, thereby improving system efficiency and potentially extending the life of the 12V battery system(s) by more accurately monitoring their parameters and controlling their charging.

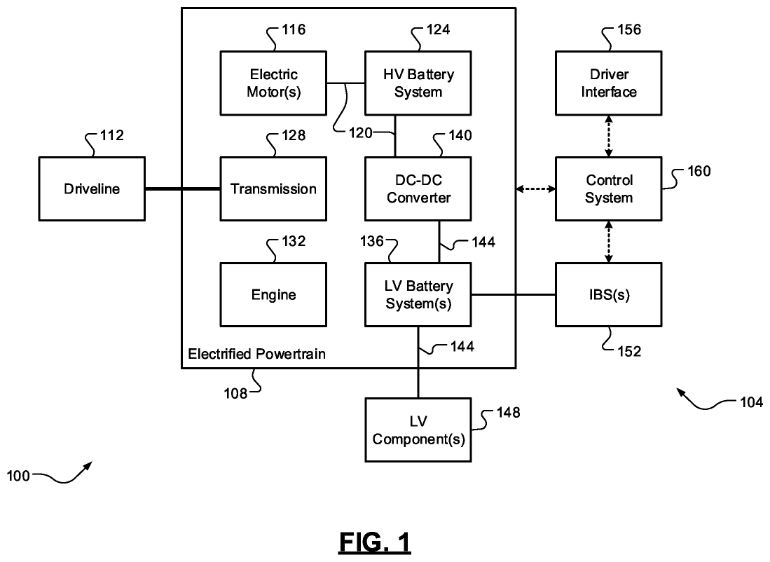

Referring now to FIG. 1, a functional block diagram of an electrified vehicle 100 having an example low voltage battery charging control system 104 according to the principles of the present application is illustrated. The electrified vehicle 100 comprises an electrified powertrain 108 that is configured to generate and transfer drive torque to a driveline 112 for vehicle propulsion. The electrified powertrain 108 includes one or more electric motors 116 powered by a high voltage (HV) bus 120 that is connected to a high voltage battery pack or system 124. The drive torque generated by the electrified powertrain 108 is transferred to the driveline 112 via a gearset or transmission 128 (e.g., a multi-speed automatic transmission). In some implementations, the electrified powertrain 108 also includes an internal combustion engine 132 configured to combust a fuel/air mixture to generate torque that could be used for propulsion and/or converted to electrical energy for recharging the high voltage battery system 120. A control system 160 controls operation of the electrified vehicle 100, including primarily controlling the electrified powertrain 108 to generate a desired amount of drive torque to satisfy a driver torque request provided via a driver interface 156 (e.g., an accelerator pedal).

The electrified powertrain 108 also includes one or more low voltage (LV) battery systems 136, also referred to herein as “12V batteries” or “12V battery systems” although it will be appreciated that their voltage ratings could be slightly different than 12V. The low voltage battery system(s) 136 are connected to a direct current (DC) to DC (DC-DC) converter 140, which steps-down a high voltage of the high voltage bus 120 or steps-up a low voltage of a low voltage bus 144 as desired (e.g., for charging the low voltage battery system(s) 136 via the high voltage bus 120). The electrified vehicle 100 includes a set of low voltage components 148 that are configured to be powered by the low voltage battery system(s) 136. Non-limiting examples of these components 148 include mechanical pumps, fans, and displays. Each low voltage battery system 136 has an IBS 152 associated therewith, which is configured to measure a set of operating parameters of the respective low voltage battery system 136 (current, voltage, SOC, state of health (SOH), etc.). As part of the techniques of the present application, the control system 160 receives these measurements from the IBS(s) 152, which will now be described in greater detail.

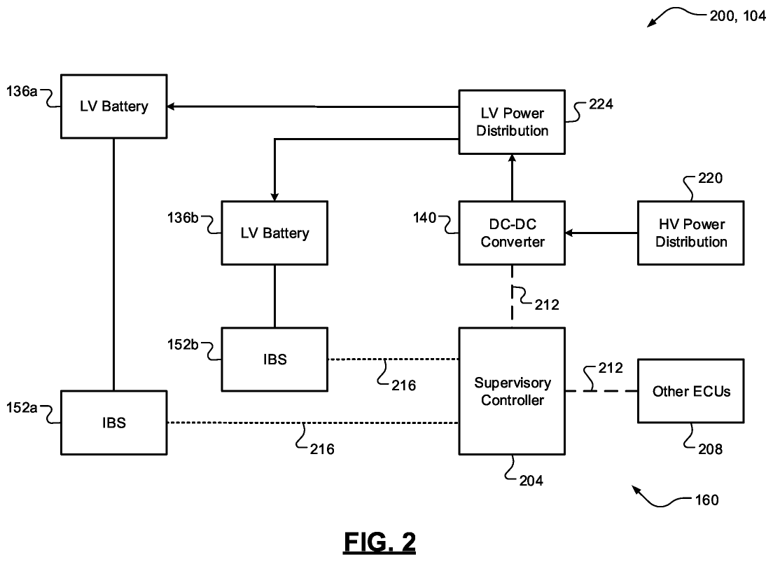

Referring now to FIG. 2 and with continued reference to FIG. 1, a functional block diagram of an example architecture 200 of the low voltage battery charging control system 104 according to the principles of the present application is illustrated. As shown, there are two low voltage battery systems 132a and 132b. Multiple low voltage battery systems could be desired for the electrified vehicle 100 to add redundancy, such as for improved functional safety relating to advanced driver assistance (ADAS) and autonomous driving and/or vehicle securement systems/features of the electrified vehicle 100. Each of the low voltage battery systems 132a, 132b could be either a 12V lead-acid type or AGM type battery that does not have its own independent/standalone controller (e.g., compared to other low voltage Li-ion battery systems). The low voltage battery systems 132a, 132b have IBSs 152a, 152b associated therewith (e.g., hardwired connected to), respectively. As shown, the control system 160 includes a supervisory controller 204 and a plurality of other ECUs 208 connected to the supervisory controller 204 via a CAN 212.

For example, the supervisory controller 204 could be a HCP or another electrified powertrain controller and the plurality of other ECUs could include, for example only, an engine control module (ECM), a transmission control module (TCM), and a body control module (BCM) that would typically connect to the IBSs 152a, 152b. In the system 200 of the present application, however, the IBSs 152a, 152b are each connected to the supervisory controller 204 via a LIN bus 216. While shown as the same LIN bus 216, it will be appreciated that these could be two separate LIN bus lines. One benefit of connecting these IBSs 152a, 152b to the LIN bus 216 is that the LIN bus 216 is already present (i.e., preexisting) to connect other suitable LIN-based components to the supervisory controller 204. Thus, no new/additional LIN bus lines are necessary, which reduces costs/complexity. The supervisory controller 204 is thus able to enable the LIN bus 216 to receive measurements of the parameters of the low voltage battery systems 136a, 136b from via the IBSs 152a, 152b.

This can be performed, for example, during periodic wakeups of the supervisory controller 204 and also does not require the supervisory controller 204 to wakeup the CAN 212 and all of the other ECUs 208 associated therewith. Once the supervisory controller 204 has determined that charging of the low voltage battery systems 132a, 132b is needed, the supervisory controller 204 can command the DC-DC converter 140 (via the CAN 212) such that the DC-DC converter 140 steps-down a high voltage provided by a high voltage distribution block 220 (e.g., the high voltage bus 120) and provide the stepped-down low voltage to a low voltage power distribution block 224 (e.g., the low voltage bus 144). The low voltage power distribution block 224 may also include circuity or componentry to split or otherwise divide the charging current flowing to the two low voltage battery systems 132a, 132b, as these low voltage battery systems 132a, 132b may have different voltage levels or SOCs. The specific conditions for waking up the supervisory controller 204 and other features relating to the low voltage battery charging control method of the present application will now be discussed in greater detail.

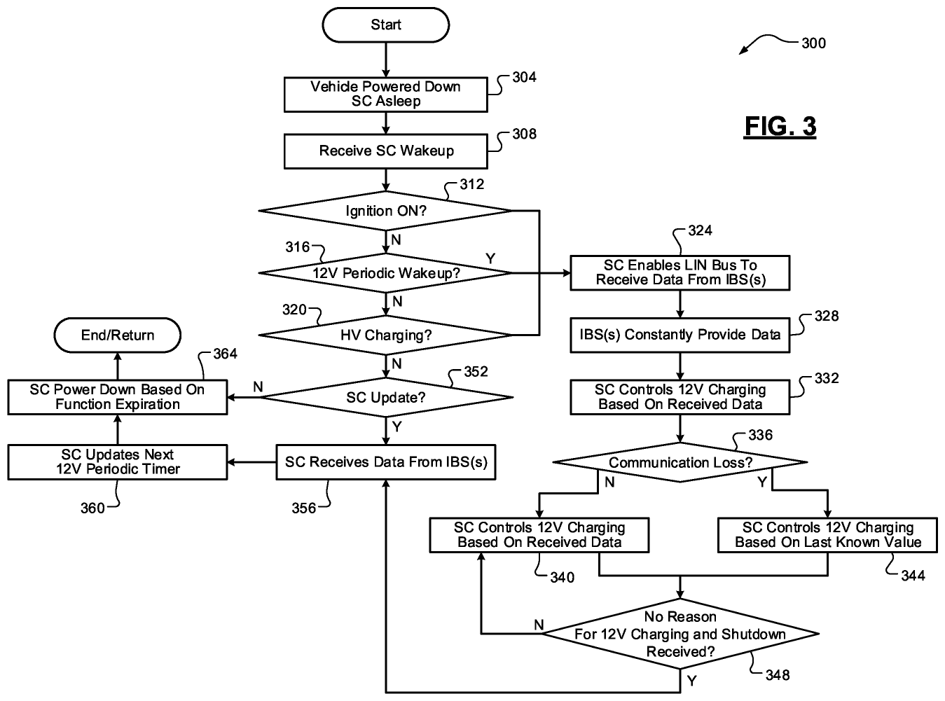

Referring now to FIG. 3 and with continued reference to FIGS. 1-2, a flow diagram of a low voltage battery charging control method 300 for an electrified vehicle according to the principles of the present application is illustrated. While the method 300 specifically references components of the electrified vehicle 100 and the architecture 200, it will be appreciated that the method 300 could be applicable to any suitably configured electrified vehicle having a conventional 12V battery system and an associated IBS. It will also be appreciated that preconditions for this control method 300 include the arrangement of an IBS on an existing LIN bus associated with a supervisory controller as discussed herein. At 304, the vehicle 100 is powered down and the supervisory controller (SC) 204 is asleep. At 308, the SC 204 receives a wakeup request and is woken up.

At 312, the SC 204 determines whether the wakeup request was an ignition ON request (e.g., to power up the electrified powertrain 108). When true, the method 300 proceeds to 324. Otherwise, the method 300 proceeds to 316. At 316, the SC 204 determines whether the wakeup request was a periodic 12V wakeup request. When true, the method 300 proceeds to 324. Otherwise, the method 300 proceeds to 320. At 320, the SC 204 determines whether the wakeup request was for high voltage (HV) charging (e.g., plug-in charging). When true, the method 300 proceeds to 324. When false, the method 300 proceeds to 352. At 324, the SC 204 enables the LIN bus 216 to receive data from the IBSs 152a, 152b. At 328, the IBSs 152a, 152b constantly provide data (battery parameter measurements) to the SC 204 via the LIN 216. At 332, the SC 204 controls 12V (low voltage) charging based on the received data from the IBSs 152a, 152b. At 336, the SC 204 determines whether a communication loss occurs during the 12V charging control.

When true, the method 300 proceeds to 344. Otherwise, the method 300 proceeds to 340. At 340, the SC 204 continues 12V (low voltage) charging control based on the received data. At 344, on the other hand, the SC 204 controls 12V charging based on the last known values (e.g., previously-received data from the IBSs 152a, 152b). At 348, the SC 204 determines whether there is no reason to continue 12V charging and whether a shutdown request has been received. When both are true, the method 300 proceeds to 356. Otherwise, the method 300 returns to 340. At 352, the SC 204 determines whether the wakeup request is for an update of the SC 204. When false, the method 300 proceeds to 364. When true, the method 300 proceeds to 356. At 356, the SC 204 receives data from the IBSs 152a, 152b via the LIN bus 216. At 360, the SC 204 updates its 12V periodic timer (e.g., its next wakeup) based on the received data. At 364, the SC 204 powers down based on an expiration of the wakeup function as previously determined. The method 300 then ends or returns to 304 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A low voltage battery charging control system for an electrified vehicle, the low voltage battery charging control system comprising:
a supervisory controller configured to control a powertrain of the electrified vehicle, wherein the supervisory controller is connected to a plurality of other electronic control units (ECUs) of the electrified vehicle via a controller area network (CAN);
a first intelligent battery sensor (IBS) configured to generate a first set of measurements indicative of a first set of parameters, respectively, of a first low voltage battery system of the electrified vehicle; and
a local interconnect network (LIN) bus connecting the supervisory controller and the first IBS,
wherein the supervisory controller is configured to receive the first set of measurements from the first IBS via the LIN bus and control charging of the first low voltage battery system without waking up the CAN and the plurality of ECUs connected thereto and thereby avoiding any electrical power drain associated therewith.

2. The low voltage battery charging control system of claim 1, wherein the first IBS is not connected to a body control module (BCM) or other vehicle network supervisor module via another LIN bus.

3. The low voltage battery charging control system of claim 1, wherein the LIN bus is an preexisting LIN bus associated with the supervisory controller.

4. The low voltage battery charging control system of claim 1, wherein the first low voltage battery system does not have a separate controller or control module.

5. The low voltage battery charging control system of claim 4, wherein the first low voltage battery system is a 12 Volt lead-acid type battery.

6. The low voltage battery charging control system of claim 4, wherein the first low voltage battery system is a 12 Volt absorbent glass material (AGM) type battery.

7. The low voltage battery charging control system of claim 1, further comprising a second IBS configured to generate a second set of measurements indicative of a second set of parameters, respectively, of a second low voltage battery system of the electrified vehicle, wherein the LIN bus also connects the supervisory controller and the second IBS.

8. The low voltage battery charging control system of claim 1, wherein the supervisory controller is a hybrid control processor (HCP).

9. A low voltage battery charging control method for an electrified vehicle, the low voltage battery charging control method comprising:
providing a supervisory controller connected to a plurality of other electronic control units (ECUs) of the electrified vehicle via a controller area network (CAN), wherein the supervisory controller is configured to control a powertrain of the electrified vehicle;
providing a first intelligent battery sensor (IBS) configured to generate a first set of measurements indicative of a first set of parameters, respectively, of a first low voltage battery system of the electrified vehicle;
providing a local interconnect network (LIN) bus connecting the supervisory controller and the first IBS; and
receiving, by the supervisory controller, the first set of measurements from the first IBS via the LIN bus and controlling, by the supervisory controller, charging of the first low voltage battery system without waking up the CAN and the plurality of ECUs connected thereto and thereby avoiding any electrical power drain associated therewith.

10. The low voltage battery charging control method of claim 9, wherein the first IBS is not connected to a body control module (BCM) or other vehicle network supervisor module via another LIN bus.

11. The low voltage battery charging control method of claim 9, wherein the LIN bus is an preexisting LIN bus associated with the supervisory controller.

12. The low voltage battery charging control method of claim 9, wherein the first low voltage battery system does not have a separate controller or control module.

13. The low voltage battery charging control method of claim 12, wherein the first low voltage battery system is a 12 Volt lead-acid type battery.

14. The low voltage battery charging control method of claim 12, wherein the first low voltage battery system is a 12 Volt absorbent glass material (AGM) type battery.

15. The low voltage battery charging control method of claim 9, further comprising providing a second IBS configured to generate a second set of measurements indicative of a second set of parameters, respectively, of a second low voltage battery system of the electrified vehicle, wherein the LIN bus also connects the supervisory controller and the second IBS.

16. The low voltage battery charging control method of claim 9, wherein the supervisory controller is a hybrid control processor (HCP).
